(19) United States
(12) Patent Application Publication
(10) Pub. No.: US 2009/0144253 A1
(43) Pub. Date: Jun. 4, 2009

(54) METHOD OF PROCESSING A SET OF CONTENT ITEMS, AND DATA- PROCESSING DEVICE

(75) Inventors: Fabio Vignoli, Eindhoven (NL); Steffen Clarence Pauws, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,314

(22) PCT Filed: Nov. 15, 2005
(86) PCT No.: PCT/IB05/53755

§ 371 Date: May 15, 2007

(30) Foreign Application Priority Data
Nov. 18, 2004 (EP) 04105895.9
Mar. 31, 2005 (EP) 05102541.9

(51) Int. Cl. G06F 17/30

(52) U.S. Cl. 707/5; 707/E17.017

(57) ABSTRACT

A method of processing a set of content items, the method comprising the steps of: (150) selecting a particular one (s_{X}, 210) of the set of content items, (160) selecting a first content item (s_{Y}, 220) on the basis of a first distance value (d_{XY}, 211) representative of the distance between the particular content item and the first content item, and (180) selecting a second content item (s_{Z}, 230) on the basis of a second distance value (d_{YZ}, 221) representative of the distance between the first content item and the second content item. The particular, first and second content items may be sequentially included in a sequence of content items, e.g. for creating a playlist of content items. The invention also relates to a data-processing device for processing a set of content items, as well as to a distance data structure and a computer program product.

The invention relates to a method of processing a set of content items, a data-processing device for processing a set of content items, as well as to a distance data structure and a computer program product, for instance, to create a sequence of content items.

U.S. Pat. No. 6,545,209B1 discloses a system for generating a playlist of songs. The playlist is generated from a reference song and/or a user preference profile. The system uses music analysis algorithms to analyze intrinsic properties of the songs. A similarity value to the relationship between two respective songs is computed on the basis of the intrinsic properties of the songs. Songs which are closely related, i.e. songs with the highest similarity value, are included in the playlist.

It is a drawback of the system known from U.S. Pat. No. 6,545,209B1 that the playlist includes the same (or substantially the same) closely related (similar) songs whenever the same reference song or the same user preference profile is taken.

WO02/061750A1 discloses a method of sorting music files on the basis of a parameter. A random number is generated and added to a value of the parameter to calculate sorting criteria for each music file. The music files are then sorted in accordance with their sorting criteria, generating a playlist of the music files.

It is a drawback of the method known from WO02/061750A1 that one music file is not similar to the preceding or subsequent music file of the paylist. In other words, the playlist is not coherent.

It is desirable to provide a method of processing a set of content items, which allows generating a sequence of content items which is not the same when the same reference (particular) song is taken whenever the sequence is generated. At the same time, every content item should be similar to the preceding content item in the sequence.

The method comprises the steps of:

selecting a particular one of the set of content items,

selecting a first content item on the basis of a first distance value representative of the distance between the particular content item and the first content item, and

selecting a second content item on the basis of a second distance value representative of the distance between the first content item and the second content item.

The first content item (fci) may be the closest content item to the particular content item. For instance,

fci=argmin(d(seed,s))/C

where d(seed,s)=distance between the seed and any items belonging to the collection C.

Alternatively, the first content item may be selected randomly from a first sub-set of the first content items. The first sub-set is established in such a manner that each first content item of the first sub-set is associated with the respective first distance value which is smaller than a distance value representative of the distance between the particular content item and any content item excluded from the first sub-set. For example,

C*={s:d(seed,s)<ε}

fci=random(C*)

wherein C* is the subset of the items s belonging to the collection C that have a distance with the seed item smaller than a certain threshold. Alternatively, the subset C* can be computed by selecting the first N items closer to the seed.

To select the second content item, the distance (or, alternatively, the similarity) between the first content item and the second content item is determined. Therefore, the second content item is similar (by at least one parameter, e.g. a content genre) to the first content item. The sequence comprises, in the order of the selection, the particular, first and second content items.

In contrast to U.S. Pat. No. 6,545,209B1, the distance between the particular content item and the second content item does not need to be decisive for the inclusion of the second content item in the sequence, but, preferably, there will be a certain similarity between the particular content item and the second content item caused by the calculation of the first and second distance values with respect to the first content item.

In WO02/061750A1, the distance (similarity) between the first and second content items is not considered at all. Therefore, for example, two content items that are quite different from each other by their tempo, but are both related to the same genre as the particular content item are subsequently included in the playlist which thereby becomes inconsistent.

A data-processing device for processing a set of content items is provided, the device comprising a data processor configured to:

select a particular one of the set of content items,

select a first content item on the basis of a first distance value representative of the distance between the particular content item and the first content item, and

select a second content item on the basis of a second distance value representative of the distance between the first content item and the second content item. The device functions in accordance with the method of the present invention.

These and other aspects of the invention will be further explained and described, by way of example, with reference to the following drawings:

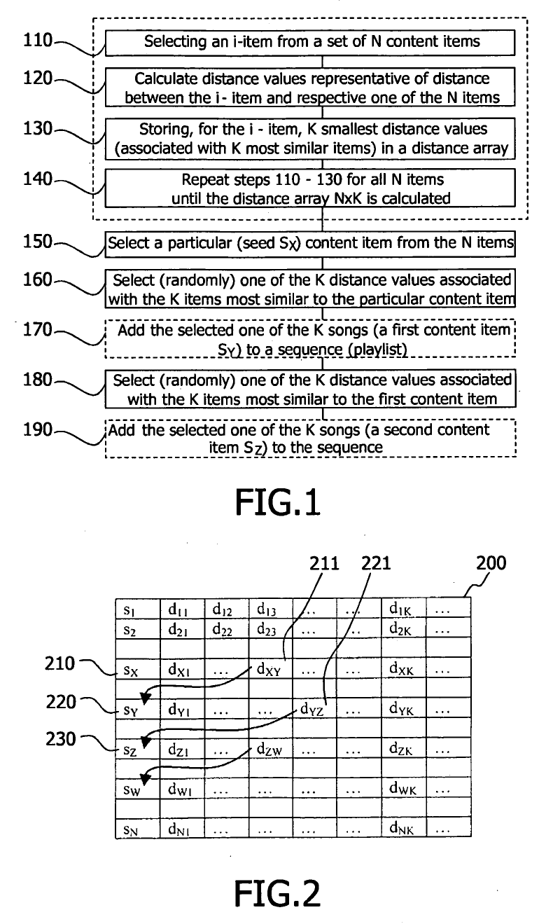

FIG. 1 is an embodiment of the method of the present invention;

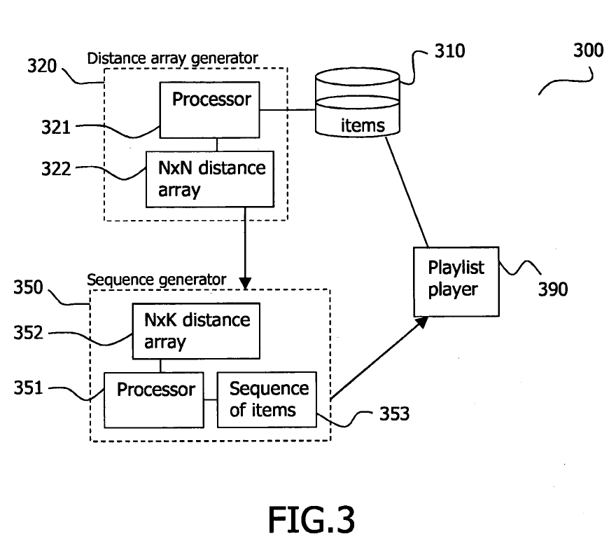

FIG. 2 is an example of a distance data structure comprising distance values representative of distances between content items;

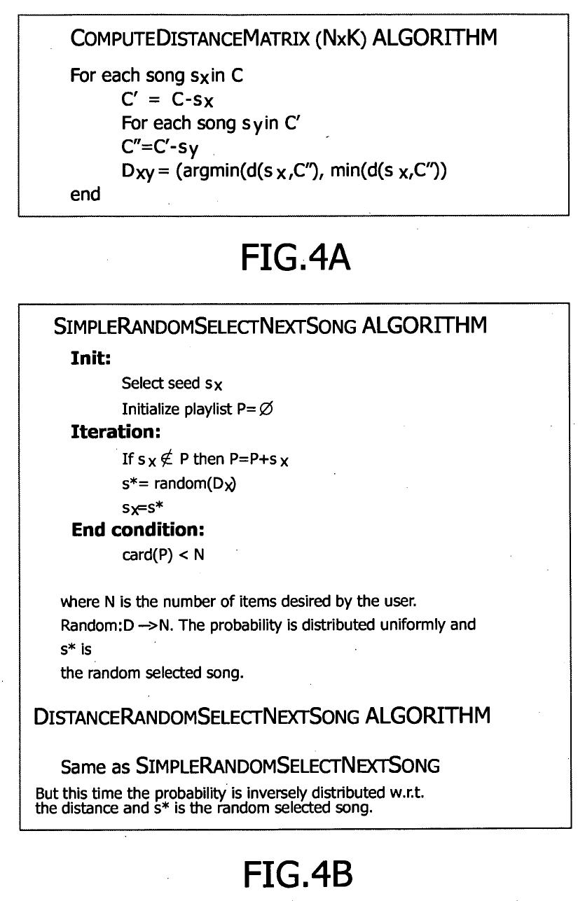

FIG. 3 is an embodiment of a data-processing system comprising a data-processing device for processing a set of content items;

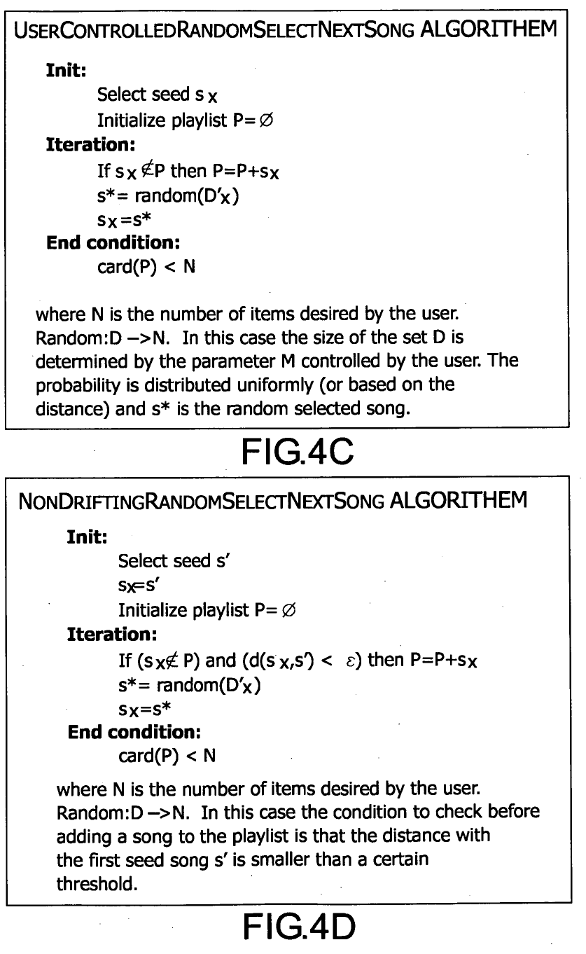

FIG. 4A shows an example of an algorithm of calculating a distance matrix;

FIG. 4B shows an example of a simple algorithm for selecting songs from a distance matrix;

FIG. 4C shows an example of an algorithm for selecting songs from the distance matrix 200, wherein the selection is user-operably controllable;

FIG. 4D shows an example of an algorithm for controlling the selection of content items with respect to the distance between the particular content item and further selected content items (e.g. the second content item).

For purposes of brevity and clarity, identical or corresponding elements such as distance values, will bear the same designations or numbering throughout the Figures.

Digital consumer electronics devices have made it possible to store a large amount of content on data carriers, e.g. hard disks. The amount of available content leads to the necessity of new ways of access that are easy and less time-consuming. Automatic generation of playlists is considered as one of the most important ways for users of digital devices to maximize the experience of listening to music while reducing the amount of time and effort needed. The easiest way to automatically generate a playlist is the shuffle button present on the majority of the devices. Unfortunately, random functions introduce too much variation in the playlist (e.g. a hard rock song right after a romantic jazz piece) and therefore do not provide the kind of experience the users are looking for.

A possible solution to the excessive randomness of the playlists is provided in WO02/31828. It enables the user to decide the amount of randomness by e.g. turning a knob from 0% to 100%. A value of 0% means that all songs played come from the selection of favorites manually updated by the users and 50% means that half the number of songs are randomly selected from the entire collection, while 100% means that all songs are randomly selected from the user's collection. The problem with this solution is that, with a long list of favorites, it is still quite probable that very diverse songs will be played after each other, even when the knob is set to 0%.

Another method of generating playlists is based on the user selection of a first song (seed song). The automatic playlist generator computes the distance d with all other songs in the collection, sorts the songs based on said distance (in ascending order) and proposes a playlist of the first songs. The distance between two songs can be based on very simple algorithms based on metadata (e.g. if same artist d=0, if different artist d=1). Other methods of generating playlists based on the distance are described in U.S. Pat. No. 6,545,209B1 and WO02/061750A1, but these methods have also problems as discussed above.

According to one aspect of the present invention, a sequence of content items is generated from a set of available content items. The sequence of content items may be used in various applications. For example, the content items are presented to a user in the order determined by the sequence. A playlist of audio (or video) content items may be generated. In another example, the content items are stored in the order determined by the sequence.

The content item may comprise at least one of, or any combination of, visual information (e.g. video images, photos, graphics), audio information, text information, and other digital data such as e.g. metadata according to the MPEG-7 standard which may be used to describe and search digitized materials by means of sampling, as well as by using lexical search terms.

The expression “audio data”, or “audio content”, is hereinafter used as data pertaining to audio comprising audible tones, silence, speech, music, tranquility, external noise or the like. The audio data may be in formats like the MPEG-1 layer III (mp3) standard (Moving Picture Experts Group), the AVI (Audio Video Interleave) format, or the WMA (Windows Media Audio) format, etc. The expression “video data”, or “video content”, is used as data which are visible such as a motion picture, “still pictures”, video text, etc. The video data may be in formats like GIF (Graphic Interchange Format), JPEG (Joint Photographic Experts Group), or MPEG-4, etc. The text information may be, for example, in the ASCII (American Standard Code for Information Interchange) format, the PDF (Adobe Acrobat Format) format, or the HTML (HyperText Markup Language) format. The metadata may be in the XML (Extensible Markup Language) format, the MPEG7 format, stored in a SQL database or any other format.

The sequence of content items is created on the basis of the similarity/distance of content of the items. The terms “similarity” and “distance” may be used interchangeably (where similarity means a small distance with the seed item). To measure the similarity between the content items, various characteristics of the content items may be taken into account.

For example, songs may be compared by their tempo, sonic, melodic movement and musical consonance characterizations or even genre. Songs may be compared by their catalog metadata, e.g. performer, composer, album, period of time. It is known to compute the Fast Fourier Transform (FFT) of short frames of the audio signal (e.g. 20-40 ms) and derive some features from it such as Mel Frequency Cepstrum Coefficients as described in J. R. Deller, Jr., J. H. L. Hansen, and J. G. Proakis, Discrete Time Processing of Speech Signals (2nd ed.), New York: IEEE Press, 2000, pp. 380-390. These MFCC may be used to determine the distance and henceforth the similarity.

The song may have a particular rhythm time, rhythm type, pitch that designates the frequency of a voice, loudness, dynamics and timbre. For instance, the song having a dominant frequency spectrum at 3 kHz is interpreted as being of the “jazz” genre, e.g. in addition to other genres. A song with a frequency spectrum of more than 3 kHz or less than 3 kHz will be of the “less of jazz genre”. For instance, a “jazz” distance value representative of the distance between two “jazz” songs may be close to 0. A “jazz” distance value representative of the distance between the “jazz” song and a “jazz/pop” song may be around 0.5. When the genre of the song is determined on the basis of a plurality of characteristics, it is possible to calculate more precisely a ratio of values of the same parameter of two songs in order to express the distance value between songs.

It is possible that a content item, e.g. a song, is of more than one genre. For instance, rhythm is a phenomenon based on the relationships between events in time. Such events may be either changing or repeating notes or chords. The rhythm may be important to organize musical events throughout a song, while the concept of tempo may be a mere quantitative parameter indicating the beats per minute. Tempo may be regarded to some extent independent of the rhythm of the music. Rhythm may not change if tempo is increased within reasonable limits. Therefore, if the song has a rhythm as in Latin music and tempo as in pop music, the song may be associated with both genres.

According to an embodiment of the method shown in FIG. 1, distances between available content items are calculated so that every content item is compared with other respective available content items. The expression “content item” is further referred to as “item” for the purpose of brevity.

In step 110, one of the N available items is selected. For example, an item s₁ is selected from all items (s₁, s₂, . . . s_{N}). A distance value d₁₂ representative of the distance between the item s₁ and the item s₂ is calculated in step 120. The distance value d₁₁ is equal to 0, of course, because it relates to the same item s₁. N distance values (d₁₁, d₁₂, . . . d_{1N}) are calculated, which are representative of respective distances between the item s₁ and items (s₁, s₂, . . . s_{N}). The distance values are in a range of, for example, 0-1.

Some distance values may be smaller than other distance values. The distance values may be compared and, in step 130, only K smallest distance values (d₁₁, d₁₂, . . . d_{1K}) are stored in a distance array (matrix) 200 shown in FIG. 2. Items 1, 2, . . . K constitute a sub-set from the set of N available items. Each K distance value is smaller than any distance value representative of the distance between the item s₁ and any item excluded from the sub-set.

In step 140, the calculations are repeated until N² distance values are computed for all N items. As a result, the distance matrix D 200 having N×K distance values and indexes is obtained. An example of an algorithm of calculating the distance matrix D is shown in FIG. 4A.

Strictly speaking, it is not required that only K smallest distance values are stored in the distance array 200. For example, the distance values (d₁₁, d₁₂, . . . d_{1K}) may be computed on the basis of a first characteristic D that is common to the items (s₁, s₂, . . . s_{N}), and similarity values (g₁₁, g₁₂, . . . g_{1K}) on the basis of a second characteristic G. Characteristics D and G may be determined independently for any item. The total number of elements stored in the distance array may be K, including the smallest distance values and the largest similarity values. In another example, all N×N distance values are stored in the distance matrix 200 if it is desirable to do so.

The distance matrix 200 obtained in steps 110-140 further serves as the basis for generating the sequence of items in steps 150-190.

In step 150, a particular item (seed sₓ) 210 is selected from the set of N available items (s₁, s₂, . . . s_{N}).

The K distance values (d_{X1}, d_{X2}, . . . d_{XK}) corresponding to the particular item 210 are identified in the distance matrix 200. The distance values in the distance array may be identified on the basis of the indices (e.g. XK attached to the respective distance value, where X indicates one of N items, and K indicates the other item in respect of which the distance d_{XK} is computed). Items 1, 2, . . . K related to the distance values (d_{X1}, d_{X2}, . . . d_{XK}) constitute a first sub-set from the set of N available items. Each K distance value (d_{X1}, d_{X2}, . . . d_{XK}) is smaller than any distance value representative of the distance between the item s_{X} and any item excluded from the first sub-set.

One of the K distance values (d_{X1}, d_{X2}, . . . d_{XK}), e.g. d_{XY} 211, is selected in step 160. The distance value d_{XY} may be selected randomly from the K distance values. Alternatively, the distance value d_{XY} may be the smallest among the K distance values. In another example, M of the K distance values are extracted from the K distance values, where the M distance values are smaller than a predetermined threshold value. The distance value d_{XY} is selected (e.g. randomly) from the M items.

An example of a simple algorithm for selecting songs from the distance matrix 200 is shown in FIG. 4B.

On the basis of the (first) distance value d_{XY} 211, a first item s_{Y} 220 is identified which is associated with the distance value d_{XY} 211 representative of the distance between the particular item s_{X} 210 and the first item s_{Y} 220. Thus, the first item s_{Y} 220 is selected from the set of N available items (s₁, s₂, . . . s_{N}). In step 170, the particular item s_{X} 210 and the first item s_{Y} 220 are sequentially added to a sequence of content items in the respective order.

In step 180, K distance values (d_{Y1}, d_{Y2}, . . . d_{YK}) corresponding to the first item s_{Y} 220 are identified in the distance array 200. Items 1, 2, . . . K related to the distance values (d_{Y1}, d_{Y2}, . . . d_{YK}) constitute a second sub-set from the set of N available items. Each K distance value (d_{Y1}, d_{Y2}, . . . d_{YK}) is smaller than any distance value representative of the distance between the item s_{Y} and any item excluded from the second sub-set.

One of the K distance values (d_{Y1}, d_{Y2}, . . . d_{YK}), e.g. d_{YZ} 221, is selected. The distance value d_{YZ} may be selected randomly from the K distance values. Alternatively, the distance value d_{YZ} may be the smallest among the K distance values. In another example, P of the K distance values are separated from the K distance values, where the P distance values are smaller than a predetermined threshold value. The distance value d_{YZ} is selected (e.g. randomly) from the P items.

In a further example, the distance value d_{YZ} 221 is selected from the K distance values (d_{Y1}, d_{Y2}, . . . d_{YK}) so that a distance value between the particular item s_{X} 210 and an item s_{Z} (not the item s_{Y}) which is associated with the distance value d_{YZ} is smaller than a predetermined distance threshold. Advantageously, the item s_{Z} may not be too distant to the particular item s_{X} (see FIG. 4D and the corresponding paragraph below).

On the basis of the (second) distance value d_{YZ} 221, a second item s_{Z} 230 is identified which is associated with the distance value d_{YZ} 221 representative of the distance between the first item s_{Y} 220 and the second item s_{Z} 230. Thus, the second item s_{Z} 230 is selected from the set of N available items (s₁, s₂, . . . s_{N}). In step 190, the second item 230 is included in the sequence of the particular item s_{X} 210 and the first item s_{Y} 220.

The distance values (d_{X1}, d_{X2}, . . . d_{XK}) or (d_{Y1}, d_{Y2}, . . . d_{YK}) may be calculated in step 120 or step 140, taking into account a rating of the items in accordance with a user profile expressing user preferences with respect to genres, styles, etc. of content items. In an extreme case, the distance array comprises only one distance value for each N available content item.

It is possible to control the selection of the first item and/or the second item, e.g. by means of a user-operable slider presented on a display screen (not shown). For example, when the first item is randomly selected from the M items (1<M<K) of the first sub-set, the increase of M will result in the increased randomness of the selection, and the decrease of M will lead to the selection of the first item from the smaller number of items of the first sub-set, and, therefore, the randomness of the selection will be smaller.

This control may enable a user to decide a degree of randomness the user wants in the generated playlist. The control is implemented as the user-operable slider (from 0% (no-random) to 100% (full-random)). A value of 50% can be interpreted as a selection of M=K/2. FIG. 4C shows an example of an algorithm for selecting songs from the distance matrix 200, wherein the selection is user-operably controllable.

The described embodiment of the method solves the problem of having a sequence of items based on one seed song (particular song) which is coherent (two consecutive items are close to each other) and varied (the sequence is different for two different runs with the same seed songs) and user-controlled (the user can specify how much randomness the sequence should have). However, the methods above might propose sequences that drift farther away from the original seed of the song. The problem of the drift may be solved as indicated in FIG. 4D. FIG. 4D shows an example of an algorithm for controlling the selection of content items with respect to the distance between the particular content item and further selected content items (e.g. the second content item). For example, a slider from 0% to 100% can be used to determine the amount of drift allowed from the selected seed. The value of E may directly be related to the maximal distance found in the current collection. A drift of 100% corresponds to a complete liberty to explore every song in the collection and a drift of 0% is a more restricted assignment.

The embodiment of the method shown in FIG. 1 relates to the generation of the sequence of the items from one seed. However, it is possible to generate the sequence on the basis of two or more seeds (two or more particular items).

The method may further comprise the following steps:

selecting a further particular content item,

selecting a further first content item on the basis of a further first distance value representative of the distance between the further particular content item and the further first content item,

selecting a representative first content item from the first content item and the further first content item,

selecting the second content item on the basis of a second distance value representative of the distance between the representative first content item and the second content item,

FIG. 3 shows an embodiment of a data-processing system 300 comprising a data-processing device 350 (a sequence generator) for processing the set of content items.

The system 300 comprises a media content database 310 comprising the set of content items, a distance array generator 320, the sequence generator 350 and a playlist player 390. The system may be distributed, i.e. its elements are remote from each other and may be remotely communicated.

The media content database 310 may be arranged to store the content items such as audio data, video data, etc. on different data carriers such as audio or video tapes, optical storage discs, e.g. CD-ROM discs (Compact Disc Read Only Memory) or DVD discs (Digital Versatile Disc), floppy and hard-drive disks, etc. in any format, e.g. MPEG (Motion Picture Experts Group), MIDI (Musical Instrument Digital Interface), Shockwave, QuickTime, WAV (Waveform Audio), etc. For example, the media content database may comprise a computer hard-disk drive, a versatile flash memory card, e.g. a “Memory Stick” device, etc.

The distance array generator 320 comprises a distance data processor 321 and distance memory means 322. The distance data processor 321 is configured to access the media content database 310 and compute the distance values as described with reference to steps 110-140 in FIG. 1. After the distance values are determined and the N×N distance array having N×N distance values is obtained, the distance data processor 321 stores the distance array in the distance memory means 322.

The sequence generator 350 comprises a sequence data processor 351, selection memory means 352, and sequence memory means 353. The sequence data processor 351 is configured to communicate with the distance memory means 322 and receive only a part of the N×N distance array so that the N×K distance array is stored in the selection memory means. In other words, it is not required that the entire N×N distance array is downloaded from the distance memory means 322 to the selection memory means 352 because the N×K distance array (K<N) comprises the smallest distance values, and the rest of the N×N distance array is preferably ignored for the further purpose of generating the sequence of content items.

The sequence data processor 351 coupled to the selection memory means further performs the steps 150-190 explained with reference to FIG. 1, and obtains the sequence of content items comprising the particular content item, the first content item and the second content item. The sequence data processor 351 further stores the sequence in the sequence memory means 353.

The distance memory means 322, the selection memory means 352 or the sequence memory means 353 may be, for example, a known RAM (random access memory) memory module. The distance data processor 321 or the sequence data processor 351 may be a central processing unit (CPU) suitably arranged to allow operation of the distance array generator 320 or the sequence generator 350 as explained herein.

The playlist player 390 may be a consumer electronics device such as a television set (TV set) with a cable, satellite or other link, a videocassette or HDD-recorder, a home cinema system, a portable CD player, a remote control device such as an I-Pronto remote control, a cell phone, etc.

The playlist player communicates with the sequence generator 350 to retrieve the sequence of content items from the sequence memory means 353. Therefore, the playlist player is enabled to reproduce the content items indicated in the sequence in the respective order. The content items, e.g. the particular, first and second content items, may be retrieved by the playlist player 390 from the media content database 310.

The sequence generator 350 may be provided with user input means (not shown), e.g. a keyboard, such as the well-known QWERTY computer keyboard, a pointing device, a TV remote control unit, etc. The user input means is configured to enable a user to set, for example, the parameter M or P to control the randomness of generating the sequence of content items. Alternatively, the user input means may be comprised in the playlist player 390, and the playlist player is arranged to communicate the parameter M or P to the sequence generator 350.

When the sequence stored in the sequence memory means 353 is the video playlist of video content items, the playlist player 390 may be arranged to present the video content items to the user using display means (not shown), for example, a CRT (cathode ray tube), LCD (Liquid Crystal Diode), or LCOS (Liquid Crystal on Silicon) rear-projection technology, a DLP (Digital Light Processing) television/Projector, a Plasma Screen display device, etc.

Variations and modifications of the described embodiment are possible within the scope of the inventive concept.

For example, in one embodiment, the sequence generator 350 and the playlist player 390 are combined in a single device, and the distance array generator 320 functions as a service provider/server.

The distance data processor 321 or the sequence data processor 351 may execute a software program to allow execution of the respective steps of the method of the present invention. The software may enable the system of the present invention independently of where it is being run. The independent method claim and the computer program product claim may be used to protect the invention when the software is manufactured or exploited to run on the consumer electronics products. The elements of the system may communicate with each other, using existing technologies, such as Bluetooth, 802.11 [a-g], UPnP (Universal Plug and Play), etc.

A “computer program” is to be understood to mean any software product stored on a computer-readable medium, such as a floppy disk, downloadable via a network, such as the Internet, or marketable in any other manner.

The various program products may implement the functions of the system and method of the present invention and may be combined in several ways with the hardware or located in different devices. The invention can be implemented by means of hardware comprising several distinct elements, and by means of a suitably programmed computer.

Use of the verb ‘comprise’ and its conjugations does not exclude the presence of elements or steps other than those defined in a claim. In the claims, any reference signs placed between parentheses shall not be construed as limiting the claim. All details may be replaced with other technically equivalent elements.

1. A method of processing a set of content items, the method comprising the steps of:
(150) selecting a particular one (s_{X}, 210) of the set of content items,
(160) selecting a first content item (s_{Y}, 220) on the basis of a first distance value (d_{XY}, 211) representative of the distance between the particular content item and the first content item, and
(180) selecting a second content item (s_{Z}, 230) on the basis of a second distance value (d_{YZ}, 221) representative of the distance between the first content item and the second content item.

2. The method of claim 1, further comprising a step of obtaining a first sub-set of the first content items (1, 2, . . . , K) from the set of content items, each first content item of the first sub-set being associated with the respective first distance value (d_{X1}, d_{X2}, . . . , d_{XK}) which is smaller than a distance value representative of the distance between the particular content item and any content item excluded from the first sub-set.

3. The method of claim 2, wherein the first content item is selected randomly from the first sub-set.

4. The method of claim 3, wherein the randomness is distributed inversely proportional to the distance.

5. The method of claim 2, wherein the first content item is selected randomly from only a specified first number (M) of the first content items of the first sub-set.

6. The method of claim 5, enabling a user to control the first number (M).

7. The method of claim 2, wherein the first content item is selected from the first sub-set if said first content item is associated with the smallest first distance value among all first content items of the first sub-set.

8. The method of claim 1, further comprising a step of obtaining a second sub-set of the second content items (1, 2, . . . , K) from the set of content items, each second content item of the second sub-set being associated with the respective second distance value (d_{Y1}, d_{Y2}, . . . , d_{YK}) which is smaller than a distance value representative of the distance between the first content item and any content item excluded from the second sub-set.

9. The method of claim 8, wherein the second content item is selected randomly from the second sub-set.

10. The method of claim 8 wherein the second content item is selected randomly from only a specified second number (P) of the second content items of the second sub-set.

11. The method of claim 8, wherein the second content item is selected from the second sub-set if said second content item is associated with the smallest second distance value among all second content items of the second sub-set.

12. The method of claim 8, wherein a distance value representative of the distance between the particular content item and the selected second content item is smaller than a predetermined distance threshold.

13. The method of claim 1, further comprising a step (170, 190) of sequentially including the particular, first and second content items in a sequence of content items.

14. The method of claim 1, further comprising the steps of:
selecting a further particular content item,
selecting a further first content item on the basis of a further first distance value representative of the distance between the further particular content item and the further first content item,
selecting a representative first content item from the first content item and the further first content item,
selecting the second content item on the basis of a second distance value representative of the distance between the representative first content item and the second content item.

15. The method of claim 1, wherein the first and/or second distance value is determined on the basis of a parameter of the content item: a genre of the content item, or a rating of the content item in accordance with a user profile.

16. A data-processing device (350) for processing a set of content items (310), the device comprising a data processor (351) configured to:
select a particular one (s_{X}, 210) of the set of content items,
select a first content item (s_{Y}, 220) on the basis of a first distance value (d_{XY}, 211) representative of the distance between the particular content item and the first content item, and
select a second content item (s_{Z}, 230) on the basis of a second distance value (d_{YZ}, 221) representative of the distance between the first content item and the second content item.

17. A distance data structure (200) comprising,
at least one first distance value (d_{XY}, 211) representative of the distance between a particular content item (s_{X}, 210) from a set of content items (310) and a respective one of first content items (s_{Y}, 220) of the set, and
at least one second distance value (d_{YZ}, 221) representative of the distance between the respective first content item (s_{Y}, 220) and a respective one of second content items (s_{Z}, 230) of the set.

18. A computer program product enabling a programmable device when executing said computer program product to function as the device as defined in claim 16.
